(19) United States
(12) Patent Application Publication
(10) Pub. No.: US 2022/0253728 A1
(43) Pub. Date: Aug. 11, 2022

(54) Method and System for Determining and Reclassifying Valuable Words

(71) Applicant: Awoo Intelligence, Inc., Taipei City (TW)

(72) Inventors: Kuo-Ming Lin, Taipei City (TW); Chen Wei Lee, Taipei City (TW); Szu-Wu Lin, Taipei City (TW)

(73) Assignee: Awoo Intelligence, Inc., Austin, TX (US)

(21) Appl. No.: 17/328,061

(22) Filed: May 24, 2021

(30) Foreign Application Priority Data
Feb. 9, 2021 (TW) 110105019

(51) Int. Cl. G06N 5/04; G06N 20/00; G06F 16/28; G06F 40/279

(52) U.S. Cl. CPC G06N 5/04; G06F 40/279; G06F 16/285; G06N 20/00

(57) ABSTRACT

Method and system for determining and reclassifying valuable words, wherein a large amount of text and valuable words are pre-inputted into a word processing server for machine learning. Moreover, the word processing server is trained on the valuable words and many labels associated with the valuable words such that it can learn and determines the valuable words in the text that meet the definition of the valuable word. The valuable word is further extracted from the text and re-classified after extraction. In addition, each valuable word is provided with various relevance labels to facilitate the subsequent application of the valuable words.

### BACKGROUND OF INVENTION

### (1) Field of the Present Disclosure

The present disclosure relates to a method and a system for determining and reclassifying valuable words, and more particularly to a system and a method that employ machine learning to extract valuable words from text, and then classify the valuable words.

### (2) Brief Description of Related Art

Currently, the online world is filled with a lot of information, articles, essays, etc. However, it is difficult for the network users, the network data processing units, or the network advertising providers to accurately obtain useful information from the large amount thereof, or to apply it. As a result, how to quickly and accurately obtain useful information from the internet world has become a very important topic in the network development. Therefore, how to replace humans with machines, actively gather text information, and use machines to learn, determine and extract useful information is the goal of all walks of life. The technical means mentioned in TW No. TWI660317 “Popularity Prediction Method for Marketing Targets and Non-transient Computer Readable Media”, first downloads the corresponding marketing category articles from social media, obtains plural keywords through word segmentation, and uses time series to determine the correlation of keywords and establishes a neural network model. When the keywords are finally used by the users, they can be used by the users according to their correlation to other keywords.

However, the above-mentioned disclosure only considers the word exposure rate when analyzing keywords, and does not take other data such as click-through rate, word occurrence frequency, word usage rate, etc. into account. Meanwhile, the technology of word segmentation is adopted when obtaining several keywords. Although word segmentation technology plays a role in the today's text extraction keywords, it may also lead to the exclusion of popular words, Chinese-English mixed language, Martian text, etc., which may be meaningful (or valuable) for data analysis although they are not keywords. Finally, when users use keywords, the aforementioned disclosure only provides other keywords with relevance or similarity, and does not mention that it can provide the data in the other categories, aspects, and fields.

In summary, the existing extraction and use of valuable words do have the above-mentioned shortcomings. As a result, how to improve the existing shortcomings of extraction and use of valuable words is a problem to be solved.

### SUMMARY OF INVENTION

It is a primary object of the present disclosure to provide a system and a method for identifying valuable words from text and reclassifying them.

According to the present disclosure, a word processing server is provided for a data provider to pre-input text, such as articles from Internet sources, email marketing texts, product descriptions, etc., which serves as basis of the valuable words in the text information. Meanwhile, a first machine learning process is performed such that the system can learn to determine valuable words in the text. Moreover, the system can then perform the second machine learning on the pre-entered valuable words and the related classification labels corresponding to the valuable words. In this way, the system can extract the valuable words from the text. After the extraction is completed, the extracted valuable words are classified. Finally, various labels are assigned to the corresponding valuable words. When there is a need for subsequent use of valuable words, not only can it be separately determined by the text, but also there are different applications according to label classification.

### BRIEF DESCRIPTION OF THE DRAWINGS

FIG. 1 is a schematic drawing I of the composition of the present disclosure;

FIG. 2 is a schematic drawing II of the composition of the present disclosure;

FIG. 3 is a flow chart of the present disclosure;

FIG. 4 is a schematic drawing I of the implementation of the present disclosure;

FIG. 5 is a schematic drawing II of the implementation of the present disclosure;

FIG. 6 is a schematic drawing III of the implementation of the present disclosure;

FIG. 7 is a schematic drawing IV of the implementation of the present disclosure;

FIG. 8 is a schematic drawing V of the implementation of the present disclosure;

FIG. 9 is a schematic drawing of another embodiment of the present disclosure; and

FIG. 10 is a schematic drawing of a further embodiment of the present disclosure.

### DETAILED DESCRIPTION OF PREFERRED EMBODIMENTS

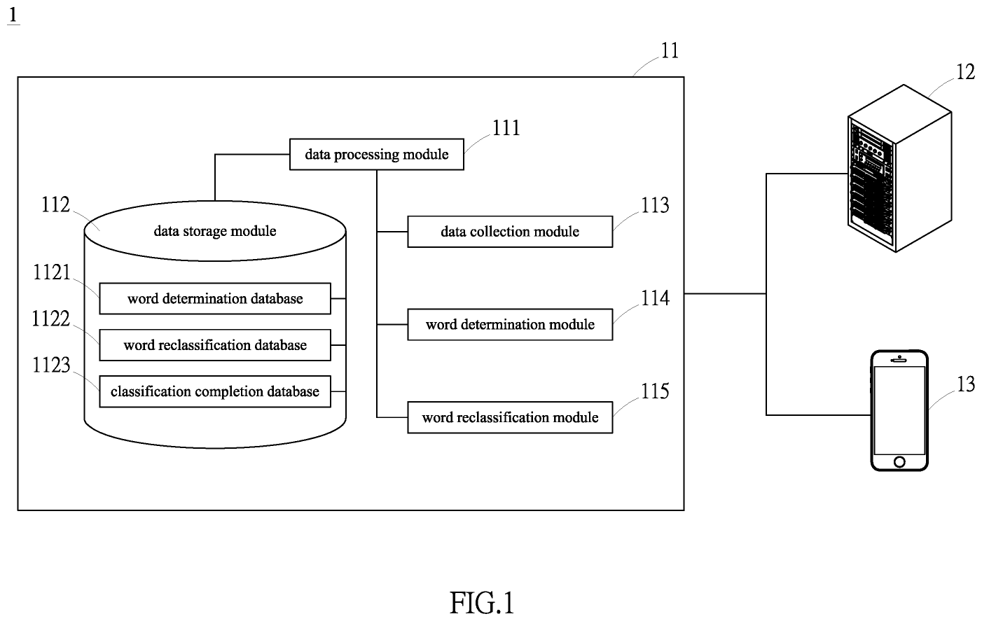

Referring to FIG. 1, a system for determining and reclassifying valuable words 1 according to the present disclosure includes a word processing server 11, and at least one third-party search system 12 and a data providing device 13 which are connected to the word processing server 11.

The word processing server 11 is employed to perform machine learning after receiving the data transmitted by the data providing device 13. Meanwhile, a plurality of models are built based on learned data. Moreover, the word processing server 11 determines the data under test collected through the third-party search system 12 and extracts valuable words. Then, the valuable words are classified. According to a classification category, a classification label information is assigned to each valuable word.

The third-party search system 12 can be any one of a search engine database, an advertisement database, a text database, or any combination thereof. Any system that enables the word processing server 11 to obtain the required input samples under test can be employed.

The data providing device 13 can be one of a mobile phone, a tablet computer, a personal computer, etc. Any devices that can provide the data required by the word processing server 11 for machine learning can be employed. The data providing device 13 mainly provides text information, valuable word information, and classification information required by the word processing server 11 for machine learning and model building. The aforementioned information will be described below.

The word processing server 11 mainly includes a data processing module 111 which is respectively connected to a data storage module 112, a data collection module 113, a word determination module 114, and a word reclassification module 115. The data processing module 111 is employed to operate the word processing server 11 and to drive the above-mentioned modules in operation. The data processing module 111, for example a central processing unit (CPU), fulfills functions such as logical operations, temporary storage of operation results, and storage of the position of execution instructions.

The data storage module 112 can store electronic data, such as SSD (Solid State Disk or Solid State Drive), HDD (Hard Disk Drive,), or any type of memory. The data storage module 112 mainly includes a word determination database 1121, a word reclassification database 1122, and a classification completion database 1123. The word determination database 1121 can be used to store and record a text information T1 and a first valuable word information L1. Both of the text information T1 and the first valuable word information L1 are provided by the data providing device 13. The text information T1 can generally includes texts such as articles from internet sources, email marketing texts, product descriptions, public documents, short texts, or combinations thereof. The first valuable word information L1 mainly corresponds to the valuable words in the text information T1. Furthermore, the valuable words include keywords, current buzzwords, mixed Chinese and English languages, Martian words and other meaningful words of the times, all of which meet the definition of the valuable word. Furthermore, the valuable words are marked by the data providing device 13. The marking work is based on associated data such as the frequency of occurrence of the valuable words in the text, frequency of use, frequency of touch, frequency of clicks, frequency of common words, etc. The word reclassification database 1122 can store a second valuable word information T2 and a classification category information L2. The second valuable word information T2 is the same as the aforementioned first valuable information T1. However, the second valuable word information T2 refers to an input data of the second machine learning mentioned below. Therefore, there is no corresponding text information. The classification category information L2 is the information corresponding to the second valuable word information T2 here. The classification category information L2 is marked by the data providing device 13, which can be the field, frequency of use, scope of use, usage habits, word length, etc. of the valuable word. The classification category information L2 can also be the attribute, function, effect, and feature, brand, etc. of the classification label. The classification completion database 1123 mainly stores a valuable word information under test and a classification label information which will be described in detail below.

The data collection module 113 is mainly used to drive the third-party search system 12 to collect a text information under test, and transmit the text information under test to the subsequent word determination module 114. The data collection module 113 mainly uses browser search, data retrieval, web crawler and other methods or a combination thereof to obtain the text information under test. The text information under test can generally refer to texts such as articles from internet sources, email marketing texts, product descriptions, public documents, short texts, or a combination thereof, but should not be limited thereto. The text information includes not only a single natural language or a single natural language family, but also multiple natural languages or mixed natural languages.

The word determination module 114 mainly determines the valuable words in the text information under test transmitted by the data collection module 113, extracts it into a valuable word information under test, and transmits it to the subsequent word reclassification module 115. The word determination module 114 mainly employs machine learning, such as supervised learning, semi-supervised learning, reinforcement learning, etc. to build models, but it is not limited thereto. The word determination module 114 mainly uses text information T1 as input data for model training. The first valuable word information L1 is used as the label data during model training to perform a first machine learning, and the model is constructed accordingly.

The word reclassification module 115 mainly classifies the valuable word information under test transmitted by the word determination module 114, and assigns a classification label information to the valuable word information according to a classification result. Finally, the valuable word information under test and the classification label information are stored in the classification completion database 1123. The word reclassification module 115 mainly employs machine learning, such as supervised learning, semi-supervised learning, reinforcement learning, etc. to build models. The word reclassification module 115 mainly uses the second valuable word information T2 as input data for model training. The classification category information L2 is used as the label data during model training to perform a second machine learning, and the model is constructed accordingly.

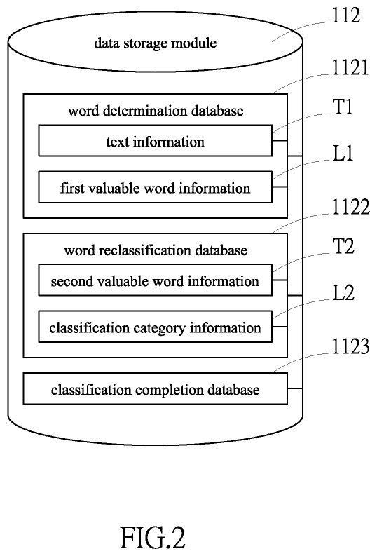

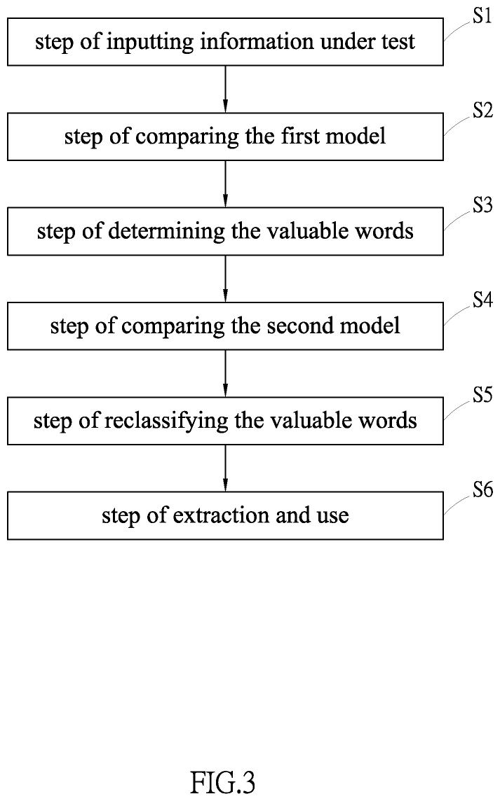

As illustrated in FIG. 3 together with FIG. 1 and FIG. 2, the steps of the present disclosure are shown as follows:

(1) Step of Inputting Information Under Test S1:

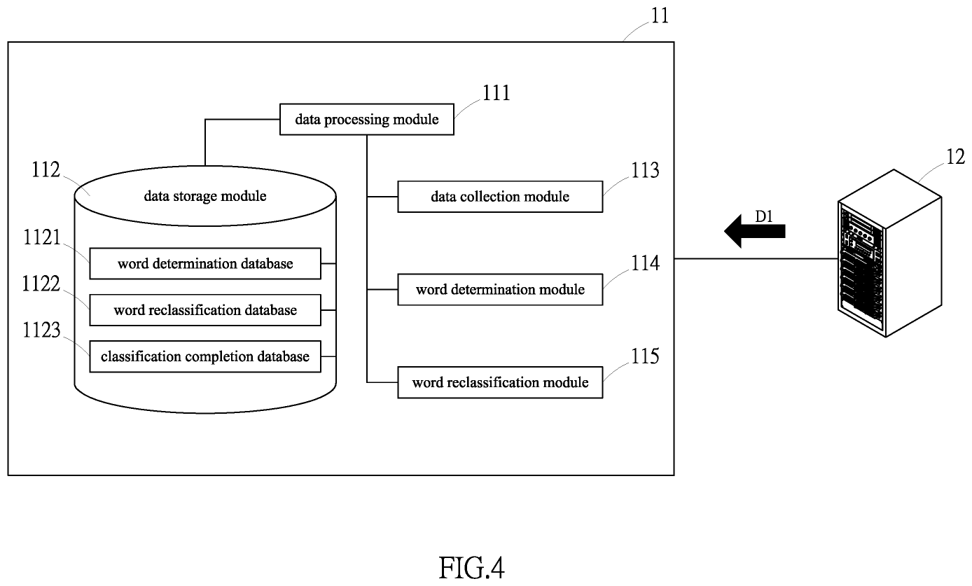

As shown in FIG. 4, the data collection module 113 of the word processing server 11 drives the third-party search system 12 to collect and transmit a text information under test D1 to the word processing server 11, and then transmit the text information under test D1 to the word determination module 114. The text information under test D1 refers to texts such as articles from internet sources, email marketing texts, product descriptions, public documents, short texts, or a combination thereof, but should not be limited thereto. The text information under test D1 includes not only a single natural language or a single natural language family, but also multiple natural languages or mixed natural languages.

(2) Step of Comparing the First Model S2:

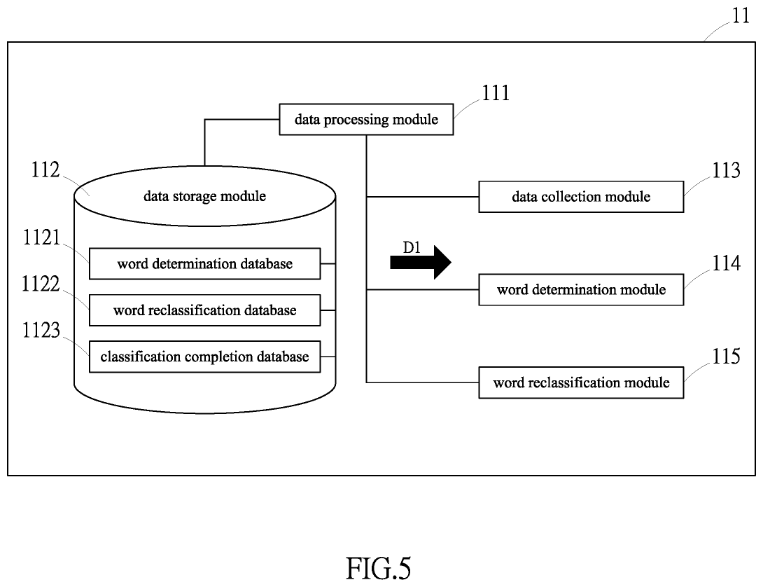

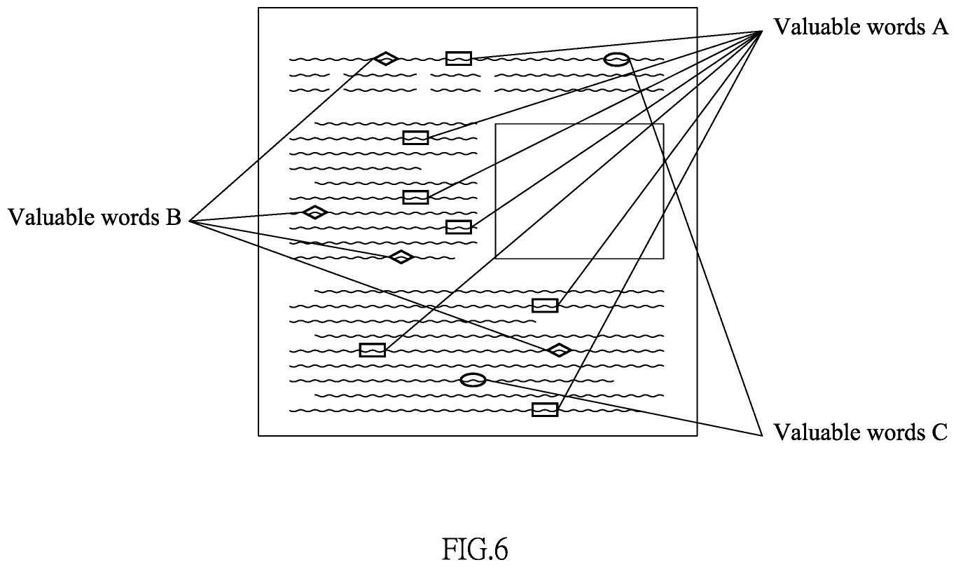

Following the above-mentioned step S1 and referring to FIG. 5 and FIG. 6, the word determination module 114 receives the text information under test D1 transmitted by the data collection module 113, and then compares and analyzes the text information under test D1 with a first machine learning. When the first machine learning model is built, the text information T1 in the word determination database 1121 is used as a first training input information. Meanwhile, the first valuable word information L1 is used as a first label information, and the model is built based thereon, and finally the text information under test D1 is analyzed, compared, and determined. The text information T1 refers to texts such as articles from internet sources, email marketing texts, product descriptions, public documents, short texts, or a combination thereof, but should not be limited thereto. The first valuable word information L1 mainly corresponds to the valuable words in the text information T1. Furthermore, the valuable words include keywords, current buzzwords, mixed Chinese and English languages, Martian words and other meaningful words of the times, all of which meet the definition of the valuable word. For example: through the first machine learning, the word determination module 114 has learned the words “anti-epidemic”, “mask”, “pneumonia”, and “COVID-19” as valuable words from the text information T1. Meanwhile, the word determination module 114 determines whether there are relevant valuable words such as “epidemic prevention”, “mask”, “pneumonia”, “COVID-19”, etc. in articles from internet sources and short online articles such as the epidemic prevention bulletin. The above-mentioned valuable words are only an example and should not be limited thereto.

(3) Step of Determining the Valuable Words S3:

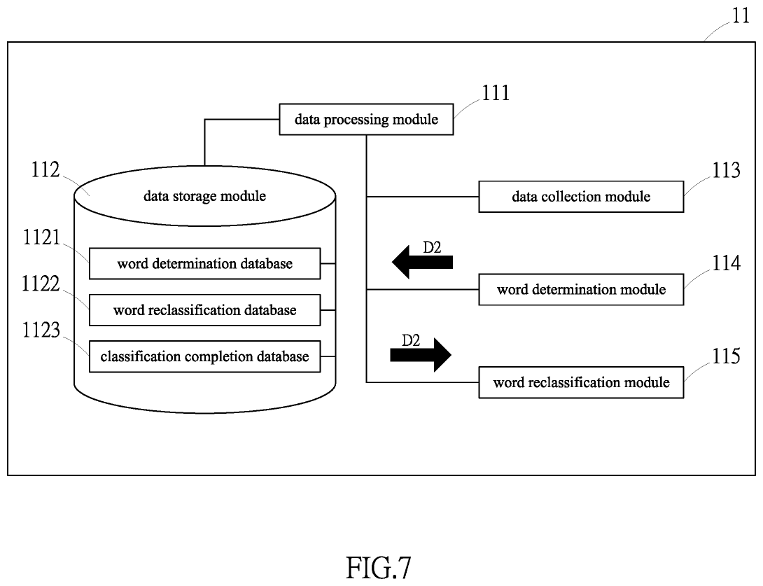

Following the above-mentioned step S2 and referring to FIG. 7, The word determination module 114 determines the text information under test D1, extracts a valuable word information under test D2 from the text in the text information under test D1 based on the first machine learning result, and transmits the valuable word information under test D2 to the word reclassification module 115. For example: the word determination module 114 extracts the words “prevention”, “mask”, “pneumonia”, and related valuable words “vaccine”, “isolation” from the epidemic prevention bulletin, and then transmits the extracted valuable words to the subsequent modules for classification. The above-mentioned valuable words are only an example and should not be limited thereto.

(4) Step of Comparing the Second Model S4:

Referring to FIG. 7, the word reclassification module 115 receives the valuable word information under test D2 extracted by the word determination module 114, and analyzes and compares the valuable word information under test D2 with a second machine learning. When the second machine learning model is built, the second valuable word information T2 in the word reclassification database 1122 is used as a second training input information. Meanwhile, the classification category information L2 is used as a second label information, and the model is built based thereon. Finally, the valuable word information under test D2 is analyzed and compared. The second valuable word information T2 refers to keywords, buzzwords, synonyms, homophones, etc., but should not be limited thereto. The classification category information L2 is mainly the classification category corresponding to the second valuable word information T2. Furthermore, the classified category information L2 may include the field, frequency of use, scope of use, usage habits, word length, etc. of the valuable word in the second valuable word information T2, but should not be limited thereto. For example: through the second machine learning, the word reclassification module 115 has learned from the second valuable word information T2 that the classification of “mask” may include medical treatment, disease, food, health, traffic, etc. In particular, the category to which it belongs may also include the label attributes being classified. The label attributes may include the brand, product features, functions, effects, and utility of “masks”. In addition, the classification of pneumonia may include medical treatment, disease, infection, and influenza while the classification of “COVID-19” may include the classifications such as medical treatment, coronavirus, global impact, and virus variants, but should not be limited thereto.

(5) Step of Reclassifying the Valuable Words S5:

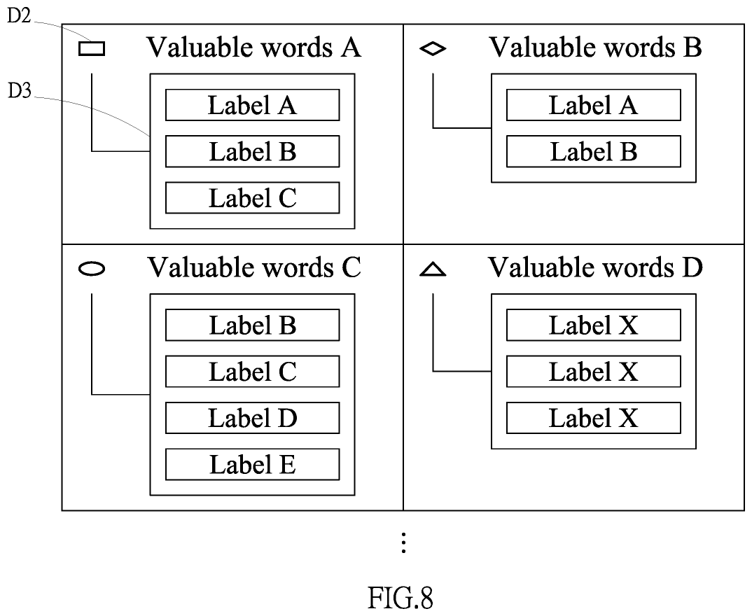

Following the above-mentioned step S4 and referring to FIG. 8, the word reclassification module 115 determines the valuable word information under test D2. Based on a second machine learning result, the word reclassification module 115 assigns a classification label information D3 to the valuable word information under test D2. Finally, the word reclassification module 115 stores the valuable word information under test D2 and the classification label information D3 in the classification completion database 1123. The classification label information D3 is the same as the classification category information L2 which may include the field, frequency of use, scope of use, usage habits, word length, etc. of the valuable word information under test D2, but should not be limited thereto. As shown in the step S3 of determining the valuable words, the valuable words “anti-epidemic”, “mask”, “pneumonia”, “vaccine”, and “quarantine” are all classified as medical treatment. “Mask” may be classified as disease, food, and health, while “pneumonia” may be classified as medical treatment, disease, infection, flu, etc. The above-mentioned valuable words and classifications are only an example and should not be limited thereto.

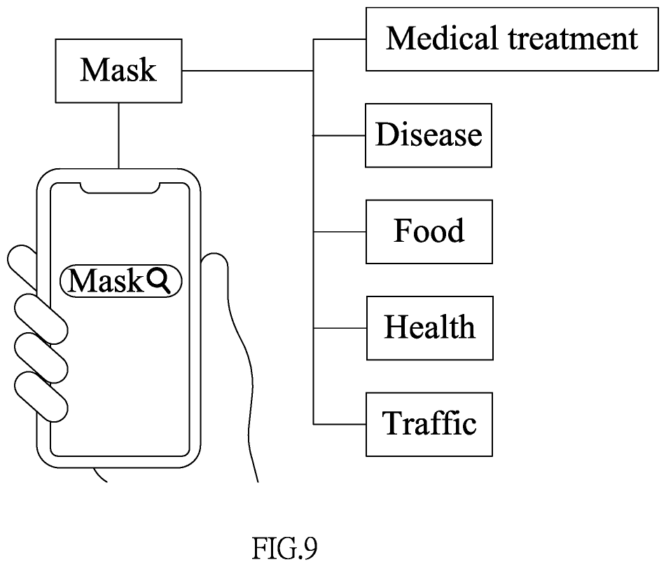

As shown in FIG. 9, the above-mentioned step S5 of reclassifying the valuable words is followed by a step of extraction and use S6. When a user uses a client device to search, extract or use the valuable words through the word processing server 11, the classification label corresponding to the valuable words is also extracted by the word processing server 11 and used by the client device. For example: A user A uses a mobile phone to search for “mask” through the word processing server 11, and the classification labels (such as medical treatment, disease, food, health, and transportation) of “mask” are also extracted for the user A to use. The above-mentioned valuable words and classifications are only an example and should not be limited thereto.

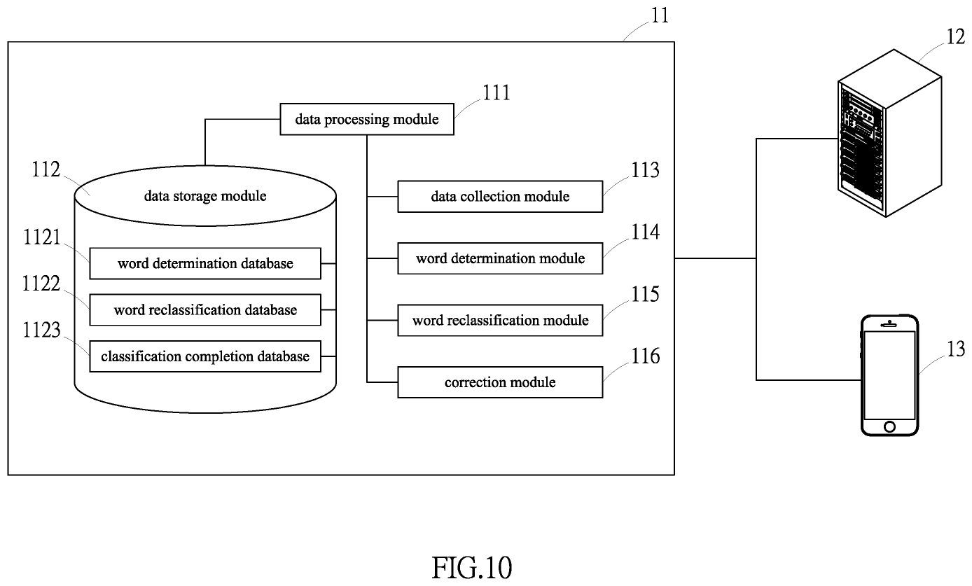

As shown in FIG. 10, the word processing server 11 may further include a correction module 116. The correction module 116 can receive a correction information provided by the data providing device 13 and adjust the first machine learning result of the word determination module 114 and the second machine learning result of the word reclassification module 115 according to the received correction information. For example: the data providing device 13 transmits a correction message to delete the classification label “food” from the “mask”. After the correction module 116 receives the correction information, the word reclassification module 115 is adjusted. The above-mentioned valuable words and classifications are only an example and should not be limited thereto.

According to the present disclosure, the system employs a secondary machine learning method to enable the system to extract the valuable words from the text, then classify the valuable words, and assign various labels to the valuable words according to the classification category. Accordingly, the present disclosure can indeed achieve the purpose of identifying valuable words from the text and reclassifying the valuable words.

### REFERENCE SIGN

1 system for determining and reclassifying valuable words
11 word processing server
12 third-party search system
111 data processing module
112 data storage module
1121 word determination database
1122 word reclassification database
1123 classification completion database
113 data collection module
114 word determination module
115 word reclassification module
116 correction module
13 data providing device
T1 text information
L1 first valuable word information
T2 second valuable word information
L2 classification category information
D1 text information under test
D2 valuable word information under test
D3 classification label information
S1 step of inputting information under test
S2 step of comparing the first model
S3 step of determining the valuable words
S4 step of comparing the second model
S5 step of reclassifying the valuable words
S6 step of extraction and use

What is claimed is:

1. A method for determining and reclassifying valuable words, comprising the following steps:
inputting the information under test, wherein a data collection module of a word processing server collects a text information under test through a third-party search system, and transmits the text information under test to a word determination module of the word processing server;
comparing the first model, wherein the word determination module analyzes, compares, and determines the valuable words in the text information under test, and the word determination module uses a text information in a word determination database as a first training input information and a first valuable word information as a first label information for performing a first machine learning;
determining the valuable words, wherein the word determination module extracts a valuable word information under test from the text information under test based on a first machine learning result, and transmits the valuable word information under test to a word reclassification module;
comparing the second model, wherein the word reclassification module analyzes, compares, and classifies the valuable word information under test, and the word reclassification module uses a second valuable word information in a word reclassification database as a second training input information and a classification category information as a second label information for performing a second machine learning; and
reclassifying the valuable words, wherein the word reclassification module assigns a classification label information to the valuable word information under test according to a second machine learning result and stores the valuable word information under test and the classification label information in a classification completion database.

2. The method as claimed in claim 1, wherein the text information comprises articles from internet sources, email marketing texts, product descriptions, public documents, short texts, or a combination thereof.

3. The method as claimed in claim 1, wherein the first text information, the first valuable word information, the second valuable word information, and the classification category information are provided by a data providing device.

4. The method as claimed in claim 1, wherein the first machine learning and the second machine learning employ one of a supervised learning method, a semi-supervised learning method, and a reinforced machine learning method.

5. The method as claimed in claim 1, further comprising a step of extraction and use following the step of reclassifying the valuable words, wherein, when a user uses a client device to extract the valuable word through the word processing server, the classification label is also extracted by the word processing server.

6. A system for determining and reclassifying valuable words, comprising:
a word processing server having a data processing module which respectively connected to a data storage module, a data collection module, a word determination module, and a word reclassification module, wherein the data processing module is employed to operate the word processing server;
wherein the data storage module comprises a word determination database, a word reclassification database, and a classification completion database;
wherein the data collection module collects a text information under test and transmits the text information under test to the word determination module;
wherein the word determination module uses a text information stored in the word determination database as a first training input information and a first valuable word information as a first label information for performing a first machine learning, and the word determination module determines a valuable word information under test from the text information under test according to a first machine learning result, extracts the valuable word information under test and transmits the valuable word information under test to the word reclassification module;
wherein the word reclassification module uses a second valuable word information in the word reclassification database as a second training input information and a classification category information as a second label information for performing a second machine learning, and the word reclassification module classifies the valuable word information under test based on a second machine learning result, assigns a classification label information to the valuable word information under test according to the second machine learning result and stores the valuable word information under test and the classification label information in the classification completion database;
a third-party search system configured to provide the text information under test to the word processing server; and
a data providing device configured to provide the text information, the first valuable word information, the second valuable word information, and the classification category information to the word processing server.

7. The system as claimed in claim 6, wherein the text information comprises articles from internet sources, email marketing texts, product descriptions, public documents, short texts, or a combination thereof.

8. The system as claimed in claim 6, wherein the first machine learning and the second machine learning employ one of a supervised learning method, a semi-supervised learning method, and a reinforced machine learning method.

9. The system as claimed in claim 6, wherein the word processing server further includes a correction module, and the correction module receives a correction information provided by the data providing device and adjusts the first machine learning result and the second machine learning result according to the received correction information.
